(19) United States
(12) Patent Application Publication
(10) Pub. No.: US 2002/0111782 A1
(43) Pub. Date: Aug. 15, 2002

(54) Method for simulating chemical reactions

(75) Inventors: Werner Klaffke, Vlaardingen (NL); Shail Patel, Bebington (GB); Jeremy Andrew Rabone, Bebington (GB); Stephen William Russell, Vlaardingen (NL); Johannes Theodorus Tissen, Vlaardingen (NL)

Correspondence Address: UNILEVER, PATENT DEPARTMENT, 45 RIVER ROAD, EDGEWATER, NJ, 07020, US

(73) Assignee: Lipton, Division of Conopco, Inc.

(21) Appl. No.: 09/909,634

(22) Filed: Jul. 20, 2001

(30) Foreign Application Priority Data
Jul. 21, 2000 (EP) 00306250.2

(51) Int. Cl. G06G 7/48

(52) U.S. Cl. 703/12

(57) ABSTRACT

A process for simulating complex chemical reaction pathways, wherein the simulation is based on transformations with relative probabilities that helps predicting the outcome of processes that may involve multiple chain reactions and/or parallelism and/or feedback or feed forward loops.

### FIELD OF THE INVENTION

The present invention relates to a process for simulating (chemical) reactions. More in particular, this invention relates to a simulation of complex chemical reaction pathways, wherein the simulation is based on reactions with relative probabilities.

### BACKGROUND OF THE INVENTION

Simulating chemical reactions is a useful tool in a wide range of industries, and applications are e.g. designing the most efficient reaction pathways, risk analysis in chemical plants, formation of flavouring or aroma compounds, biochemical pathways, processes of sulphonation and others.

There are a number of approaches in the literature which simulate reaction pathways either synthetically or retro-synthetically. These may be summarised as:

(i) Search engines based on large databases, e.g. CASREACT, CRDS, BEILSTEIN, ORAC, REACCS, SYNLIB, and CHEMINFORM which classify reactions and allow searches by molecule fragments and functional groups.

(ii) Computer-aided Synthesis, e.g. PSYCHO, DARC-SYNOPSIS and REACTION simulates reactions in the forward direction from start reactants.

(iii) Computer-aided Retro-synthesis e.g. LHASA, RETROSYN, OCSS and SYNCHEM, builds the synthetic tree for a user-specified molecule. Some also support synthesis in the forward direction, i.e. allow the user to specify start compounds to predict end products e.g. SOS^{[4]}, MARS^{[5]} and SYNGEN.

(iv) Mathematical models, e.g. energy calculations (EROS) or electron density calculations (CAMEO), are used to predict chemical reactions.

(v) Combinatorial Chemistry e.g., Diversity Explorer^{[1]}, Chem-X^{[2]}, or Legion^{[3]}, for building virtual combinatorial libraries.

Bador^{[6]} et al. give a review of the approaches listed under (i) to (iv).

As the intended use of these approaches is generally an aid for the synthetic chemist, they have drawbacks such as: user input is required to proceed, and/or only a single branch of the reaction pathways is followed, or other disadvantages. These disadvantages are particularly a handicap when wishing to model complex chemical reactions that have for example reactions or transformations that occur subsequently, and/or in loops (forward, backward, or mixed), and/or in parallel.

In order to predict the outcome of processes that involve multiple chain reactions, a system that can cope with inherent parallelism and feedback or feed forward loops, and operate without user interaction to construct the complete reaction graph, is preferred. Prickett and Mavrovouniotis^{[7]} have developed a theoretical system that models generic complex reaction systems. This iteratively applies known elemental reaction steps, according to theoretical chemistry, to the reactants and all intermediates.

This method has some disadvantages such as:

it is theoretically sound, but may not take into account the practical difficulties with scaling up a theoretical approach for industrial purposes,

it does not take into account the different rate constants or kinetics of the reactions involved,

it does not describe a way of validating the results, and updating the simulation using experimental data.

### SUMMARY OF THE INVENTION

Hence, there was a need for a method for modelling or simulating (complex) chemical reactions or processes that helps predicting the outcome of processes that may involve multiple chain reactions, a system that can cope with inherent parallelism and feedback or feed forward loops, and operate without user interaction.

It has now been found that the above may be achieved (at least in part) by a method for simulating a chemical process, which process may comprise multiple branches of reaction pathways and/or feed back/forward loops and/or parallel reaction branches by an iterative procedure of applying:

a ‘Reaction Set’ describing transformations and their probabilities that may take place in the chemical reaction or process on

a ‘Soup’ of molecules representing the state of the system.

### DETAILED DESCRIPTION OF THE INVENTION

The system according to the present invention is similar to the system of Prickett and Mavrovouniotis^{[7]}, but better in three significant ways:

1) taking into account reaction rate constants as reaction probabilities

2) and optionally heuristic blocking of the reactions into subsets that guide the reactions in a computationally effective manner

3) and optionally fine-tuning the reaction and reaction rate databases by comparison with experimental results.

The simulation of complex chemical reaction pathways according to the present invention (hereafter called Iterated Reaction Graphs—IRG) model complex reaction pathways by simulating the reaction steps in parallel. An Iterated Reaction Graph has two main elements:

1. A ‘Soup’ of molecules representing the current state of the system

2. A ‘Reaction Set’ describing transformations (=simulated reactions) that may take place in the chemical process that is to be modelled or simulated, and probabilities (=simulated reaction rates) of said reactions to yield molecules.

ad 1) In the ‘Soup’, molecules may be represented by any computer readable format, e.g. expressed as SMILES^{[1]}, a simple line notation of 2-dimensional connection tables. Preferably, during the iterative procedure the newly formed compounds are added back to the Soup, which forms (part of) the virtual mass distribution. Additionally, it is preferred that the Soup at the start of the simulation is equal to the starting mixture of molecules.

ad 2) In order to describe the reactions that may take place in the process that is to be simulated the ‘Reaction Set’ may suitably contain (in computer readable format):

a reaction database, which contains various transformations that may take place in the reaction or process to be simulated. These transformations can usually be found in literature.

a reaction kinetic database, containing probabilities for transformations to take place in the reaction database, simulating kinetic data such as rate constants for the reactions.

Furthermore, the IRG contains a computer programme directly loadable in the internal memory of a computer, comprising instructions for the simulation of complex chemical reaction pathways by iteratively applying a set of operations or computer instructions to:

A ‘Soup’ of molecules representing the current state of the system

A ‘Reaction Set’ describing transformations and probabilities that may take place in the chemical process to be simulated to produce molecules, for simulating complex chemical reactions when such product is run on a computer, and wherein the computer programme contains two main elements:

a) computer instructions for applying the transformations using the reaction set described above,

b) computer instructions for the iterative procedure of selecting molecules, applying the transformations and producing output.

The computer programme also contains typical components such as a user interface, methods of inputting and editing data, methods of probing the progress, methods for outputting results and so on.

The IRG is the iterative application of a ‘reaction set’ which is applied on a ‘soup’ of molecules. The iterations are over all reactions, and over all candidate molecules, in the various reaction blocks. Preferably, the iterative procedure is coded as a computer programme directly loadable in the internal memory of a computer

The invention further comprises a computer program product directly loadable into the internal memory of a digital computer, comprising software code portions for the simulation of complex chemical reaction pathways by iteratively applying a set of operations or computer instructions to:

A ‘Soup’ of molecules representing the current state of the system,

A ‘Reaction Set’ describing transformations that may take place in the chemical process to be simulated, with their respective probabilities, to produce molecules, and wherein the iterative procedure is coded as a computer programme directly loadable in the internal memory of a computer, wherein the iteration is coded as a computer programme, for simulating complex chemical reactions when such product is run on a computer.

Each reaction may be coded as a computer program that takes connection table input (reactants), carries out necessary rearrangements (reactions), and produces a connection table output (products). In the present document such coded (or virtual) reaction is called ‘transformation’.

At a simplistic level the reaction base operates on the molecular soup to form products:

Reaction Set: Molecular Soup→Products

The full complexity of the possible reactions may be modelled by iterating through this ‘equation’, feeding the products back into the Molecular Soup and running through the Reaction Set again, which is a part of the IRG (FIG. 1).

The full reaction graph^{[8-12]}, where molecules are nodes and reactions are arcs may be defined as the set of triplets:

{<Substrate><Reaction><Product>}

For example the text below is a small fragment of a Reaction Graph, containing 3 triplets (molecules coded in SMILES):

C(═O)C(C(═CC(═C)O)O)O R1_{—}1_{—}6_endiol C(═C(C(═CC(═C)O)O)O)O

C(═O)C(C(C(C(═C)O)O)O)O R1_{—}1_{—}6_endiol C(═C(C(C(C(═C)O)O)O)O)O

C1═CN═C(C(C)O)O1 R1_{—}4_{—}2_strecker C(═CN)OC(═O)C(C)O

The full graph is reconstructed by linking products to substrates and chaining through the triplets. Examples of two relatively short but different routes to dimethyl pyrazine are given below:

<Start> C(O)C(O)C(O)C(O)C(O)C═O R1_{—}12_{—}3_sugar C(O)C(O)C(O)C(═O)C(═O)C

R1_{—}2_{—}1_retroaldol C(O)C(═O)C(═O)C R1_{—}2_{—}2_retroaldol C═O R2_{—}5_{—}4a_pyrazine

CC—1NC(C)—CNC—1

<Start> NC(C(O)C)C(═O)O R2_{—}4_{—}1strecker CC(C=O)N R2_{—}5_{—}1_pyrazine

CC1═NC(C)C═NC1 R1_{—}5_{—}3pyrazine_oxidation CC—1NC(C)—CNC—1

The size of the soup, typically 100-1000 molecules, is determined at the start, and is limited only by computer memory considerations. At the start of a run this will be composed of starting components, which, in the case of the reaction to be simulated being a Maillard-type reaction amino acids and sugars only, e.g. for glucose and threonine (coded in SMILES):

“C(O)C(O)C(O)C(O)C(O)C═O

C(O)C(O)C(O)C(O)C(O)C═O

. . .

NC(C(C)O)C(═O)O

NC(C(C)O)C(═O)O

. . . ”

There are duplicates of molecules, as the relative number of times a molecule appears simulates the concentration of that molecule in the soup. During, and at the end of a run, the soup will contain a list of end products that is the result of simulating the reactions many thousands of times. It also may contain duplicates, to simulate the relative concentration of end products, e.g.:

“C(═O)(C(═O)C)O

C(═O)(C(O)C(═O)C)O

C(═O)(C(O)C(═O)C)O

C(═O)(C(O)C)O

. . .

”

Central to the working of the program is a computer simulation of the chemical reactions (i.e. transformations) which actually may take place during the chemical process or reaction to be simulated. Each virtual reaction or transformation is coded as a programme function that conducts the following steps:

1. 2-D pattern match on substrate (input) molecule(s) according to the virtual reaction

2. Break bonds

3. Change atom hybridisation

4. Change bond types

5. Add bonds

6. Output product molecule(s)

In principle, this may be coded in any suitable computer-readable format, for example in SPL (Sybyl Programming Language^{[3]}) or any equivalent way. Such a programme may require a coding of the molecules and transformations or computer operations, which can be done e.g. in SMILES^{[8]} or SLN (the line notation from Tripos^{[3]} which is better compatible with SPL), which are then applied in the code for the Reaction Set.

The pattern matching step allows for fragment matching on the connection table of the reactive fragment necessary for the reaction to take place. Thus the chemical process is coded as a set of generic reactions which can act on a range of (different) starting molecules.

The IRG iterates through the Reaction Set, selecting reactions from the list of reactions and molecules from the ‘soup’ that relate to that reaction. Optionally, a ‘filter’ or selection criterion is build in, depending upon the specific case, which may e.g. help preventing polymerisation or will stop the simulation when desired compounds are formed, or a certain level of compound(s) is formed, or other. Such filter or selection criterion can be e.g. an upper mass limit, or a lower mass limit, or the appearance of certain specific molecule or a group of molecules, molecular mass in some range, particular functionality of a compound, toxicity, etc.

The theory for kinetics for a simple chemical reaction: A+B→P, where A and B are substrates and P is the product molecule is:

$$\frac{ⅆ [ P ]}{ⅆ t} = \frac{- ⅆ [ A ]}{ⅆ t} = {k}_{ABP} \cdot [ A ] \cdot [ B ]$$

where k_{ABP} is the rate constant for that reaction. It is in principle possible, but very time consuming, to calculate the rates of chemical reactions in solution or in an enzymatic environment from the free energy profile along the reaction coordinate. The free energy of activation has a simple relation to the rate constant in the transition state approximation:

$${k}_{ABP} = \frac{{k}_{B} \cdot T}{h} {ⅇ}^{\frac{Δ G \#}{RT}}$$

Where

| | |
|---|---|
| k_{B} | = Boltzmann constant |
| T | = temperature |
| H | = Planck's constant |
| ΔG^{#} | = free energy of activation |
| R | = gas constant |

ΔG^{#} consists of two components, the intrinsic part and the difference in free energy of solvation between the transition state and the reactants. The first can be calculated by either ab-initio or semi-empirical molecular orbital methods for both the transition state and the reactants. The difference in the free energies of salvation can be estimated using discrete solvent molecules or by continuum models. Simulation of energetic details of the reaction, however, would require the search for transition states and their respective energetic minima. This would be an impossible task to do in a definite timescale given the present computing power. Therefore, in the present invention, it was decided that the simulation of the actual reaction steps together with their respective probabilities becomes the preferred option. As a result a ‘reaction probability’ route approach has been adopted, using best guesses initially and preferably refining these empirically and/or by optimisation methods. Discretising equation (1) the following is obtained:

Δ[A]=−k_{ABP}.[A].[B].Δt

Losing the time step Δt in the constant of proportionality, and describing values as probabilities, this may be written as:

Δ(n(A))∝−p(R_{ABP}).p(A).p(B)

where

n(A)=number of molecules of A in the Soup

p(R_{ABP})=relative ‘probability’ of Reaction A +B -→P

p(X)=probability of selecting molecule X from the Soup

The joint probability p(A).p(B) may be simulated by randomly picking a pair of molecules {<molecule1>, <molecule2>}. This selection is biased by the ‘concentrations’ of molecule1 and molecule2 in the soup and therefore, over successive selections, is a reasonable approximation to the probability. p(R_{ABP}) may be simulated by assigning a ‘probability of reacting’ to each reaction R, and randomly selecting the reactions. If the selected molecules match the requirements of the reaction R then they react and the products are added to the soup. In essence this is simulating that if A & B come into contact in the ‘soup’: if they can react they should do so biased by some likelihood.

To facilitate scale-up and reduce computation time the reaction database (which is part of the reaction set) is preferably split into blocks, so that only selected reactions will occur within each block. The output from each block of reactions serves as input to one or more further blocks.

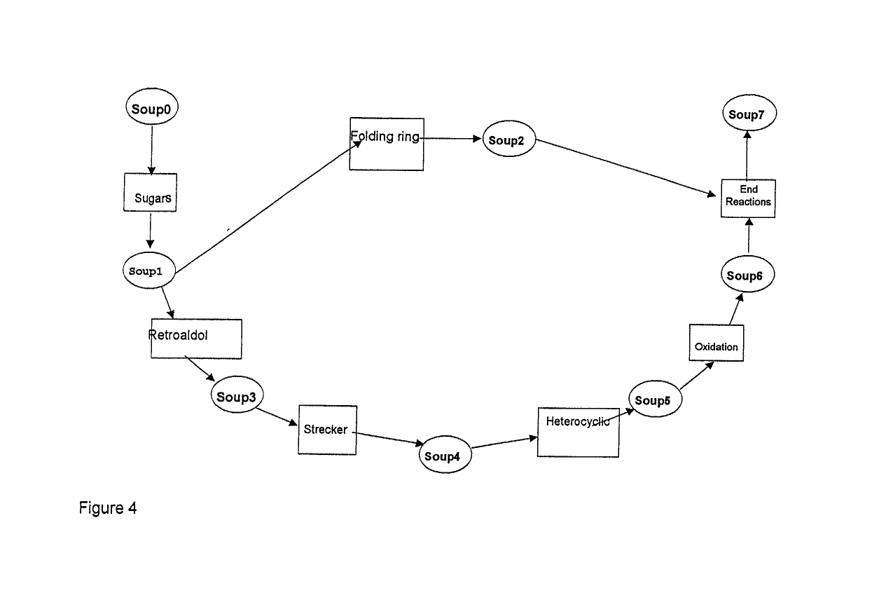

This is structured in FIG. 4 (wherein the reaction taken is a Maillard-type reaction, for illustration) according to the order in which reactions occur in the Maillard process. This refinement is not as strongly sequential as it may appear: parallel reactions may take place within each block; the same reaction may occur in more than one block; and there is a high level of traffic between the blocks.

Alternatively to simulation of the reactions, estimations for determining one or more of the N processing parameters (and/or the reactant(s)) the simulation of complex chemical reactions as set out herein before are derivable from a relationship between:

composition analyses of compounds produced,

processing parameters used for obtaining the composition analysis,

reactants,

said composition analyses being an actual mass distribution obtainable from performing at least 100 (preferably at least 1000) reactions involving heating reactants under predetermined and known processing parameters, analysing the reaction product obtained form each of the reactions above to provide composition analyses thereof, encoding it as a mass distribution. In order to achieve this, samples may be produced under well defined standard conditions. The actual mass distribution may be obtainable by conventional chemical analysis of the reaction products or the volatile fraction thereof, such as GC and/or MS techniques. If so desired, this may be combined by computerised processing of the analytical data. Needless to say, in view of the large number of experiments to be carried out, this (conducting the experiments and analysis) is preferably carried out in a robotised or automated way.

As an example, in the case of a Maillard-type reaction to be simulated, in brief, a mixture of amino acid(s) and sugar(s) may be heated in solvent, cooled, and then extracted. The composition of volatile products may be determined by Gas Chromatography or similar separation technique. The identity of each peak may be determined by Mass Spectrometry from comparison with the generated fragmentation pattern of a library. From this a Molecular Mass Distribution (MMD) pattern can be reconstructed, representing the frequency of masses of the product composition of each individual experiment. The final output of the computational IRG contains the ‘soup’ of molecules at the end of the run. This may be represented as a “Virtual Mass Distribution” (VMD) by taking relative frequencies binned by molecular weight. The experimental MMD may then be compared with the VMD.

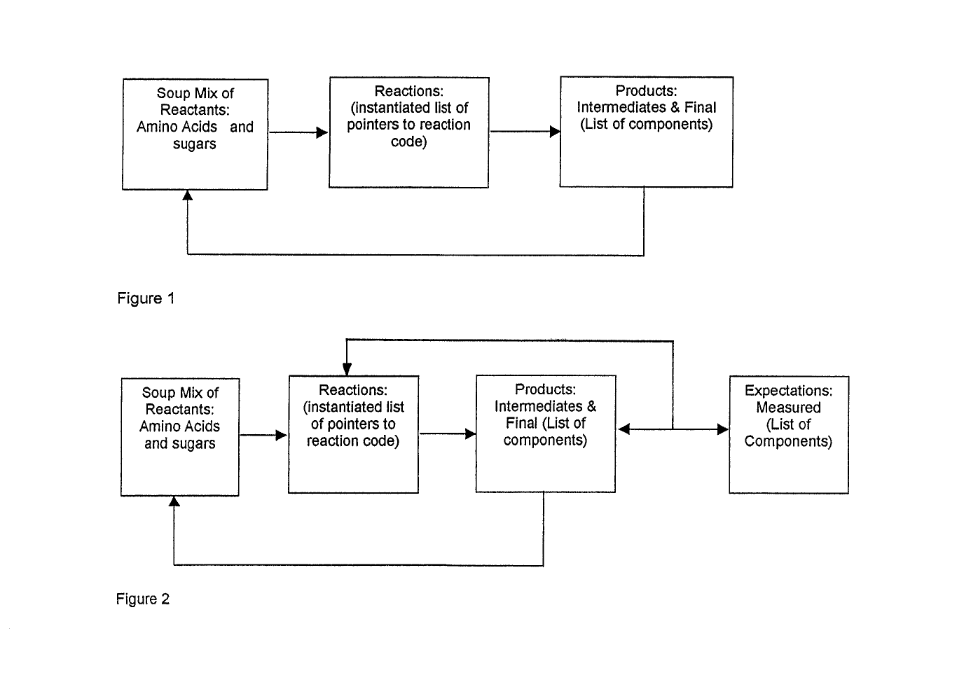

Comparison of the experimental (=actual) mass distribution with the virtual mass distribution, as generated using IRG, yields information that can be used to update the IRG and/or reaction set. E.g., compounds which show up in the experimental results but are missing in the IRG results might implicate that an elementary transformation is missing in the reaction database. Compounds present in the IRG results which are missing in the experimental mass distribution may originate from a probability of a certain transformation which is too high. The information thus acquired combined with the chemical knowledge of the user can be used to add or remove transformation steps and/or to change the probablities of some of the transformations, as is schematically given in FIG. 2.

The results described above, along with the full listing of the reaction paths, may be used as a guide to identifying where the output of the IRG may be improved by updating the values of the reaction rate parameters. The effect of such updates may easily be evaluated by running the updated IRG and comparing the results with the experimental data. If this results in an improvement the update is accepted, otherwise other updates are attempted.

The invention further relates to a computerized system comprising means for entering GC (‘fingerprint’) data and process variables to be set at the start of a chain of reactions and optional further data, and a computer programme to relate these. From such a relationship it is possible to predict process variables to obtain new desired fingerprint data, based upon already entered sensorical data, fingerprint data and process variables, and means for providing output.

In a preferred embodiment, the comparison or relationship between composition analyses of produced compounds in the form of actual and/or virtual mass distributions, and processing parameters used for obtaining the composition analysis and optional further data are obtainable using statistical methods. An example of such statistical methods may be a relationship method like linear- or non-linear regression, PLS, neural networks, gaussian procedures, etcetera.

The reaction rate parameters (probabilities) may be optimised by any suitable method. For example, the method as described below may be used.

In the case important process conditions are pH, T and S an objective or cost function related to the experimental measures is defined as:

Error(R(pH, T), S)=false_positives(S, pH, T)+false_negatives(S, pH, T);

where

R=the set of transformation rate parameters (i.e. probabilities) at the specified pH [high, med or low] and T (temperature of soup)

S=the start soup false_positives=the number of molecules the IRG has incorrectly identified as being present in the final soup false_negative=the number of molecules the IRG has failed to identify as being present in the final soup

Note that this does not take into account the peak height, but only the presence or absence of particular molecules. Then an objective function summed over the start soups for which there is experimental data may be defined:

O(R(pH, T))=Σₛ Error(R(pH, T), S)

Clearly as O(R(pH, T)) approaches 0, the IRG is producing results closer to the experimental values. Defining the optimisation problem to be to optimise R(pH, T), i.e. the rate parameters for a given pH and temperature, such that O(R(pH, T)) is minimised. This is computationally expensive but may be achieved using a standard optimisation algorithm such as Sequential Quadratic Programming or a Genetic Algorithm. For other process variables that pH and T this works similarly.

Comparing the virtual mass distribution with the actual molecular mass distribution may be further supplemented with analysis of and comparison with e.g. sensory data or other data. Such sensory data may be obtained from analysing (e.g. using a sensory panel) the reaction products of the actual experiments, and preferably the volatile fraction thereof. The analysis of sensory data may involve statistical methods for mapping the sensory data. If sufficient data are then obtained, mathematical relationships between sensorical data and processing variables may then be derived.

### References

[1] Molecular Simulations Inc., 9685 Scranton Road, San Diego, Calif. 92121-3752, USA.

[2] Oxford Molecular Group PLC, The Medawar Centre, Oxford Science Park, Oxford OX4, 4GA, United Kingdom.

[3] Tripos Inc., 1699 South Hanley Road, St. Louis, Mo. 63144,USA.

[4]Vernin, G.; Parkyani C.; Barone R.; Chanon M.; Metzger J.; Computer Assisted Organic-Synthesis of Volatile Heterocyclic Compounds in Food Flavours, Journal of Agriculture and Food Chemistry, 1987, 35, 5, 761-768.

[5] Azario, P.; Arbelot M.; Baldy A.; Microcomputer Assisted Retrosynthesis (MARS), New Journal of Chemistry, 1990, 14, 12, 951-956.

[6] Bador, P. et al; Les Systemes Informatiques de Recherche d'Information sur les Reactions Chimiques et les Systemes de Synethese Assistee par Ordinateur, New Journal of Chemistry, 1992, 16, 3, 413-423.

[7] Prickett, S. E.; Mavrovouniotis, M. L.; Construction of Complex Reaction Systems—II Molecule Manipulation and reaction application algorithms, Computers Chem. Engng., 1997, 21, 11, pp 1237-1254

[8] Weininger, D.; SMILES, a chemical language and information system, Journal of Chemical Information and Computer Science, 1998, 28,1, 31-36

[9] Lohn, J. D.; Evolving Catalytic Reaction Sets using Genetic Algorithms, IEEE World Congress on Computational Intelligence, Anchorage, Alaska. 1998, 87-492

[10] Schuster, P.; Dynamical Systems and Cellular Automata, J. Demongeot et al. (Eds), Academic Press, 1985, 255-267

[11] Banzhaf, W. et al; Emergent Computation by Catalytic Reactions, Nanotechnology, 1996, 7, 307-314

[12] Kauffman, S. A.; The Origins of Order, Oxford University Press. 1993, 303-305

### EXAMPLES

### Example 1

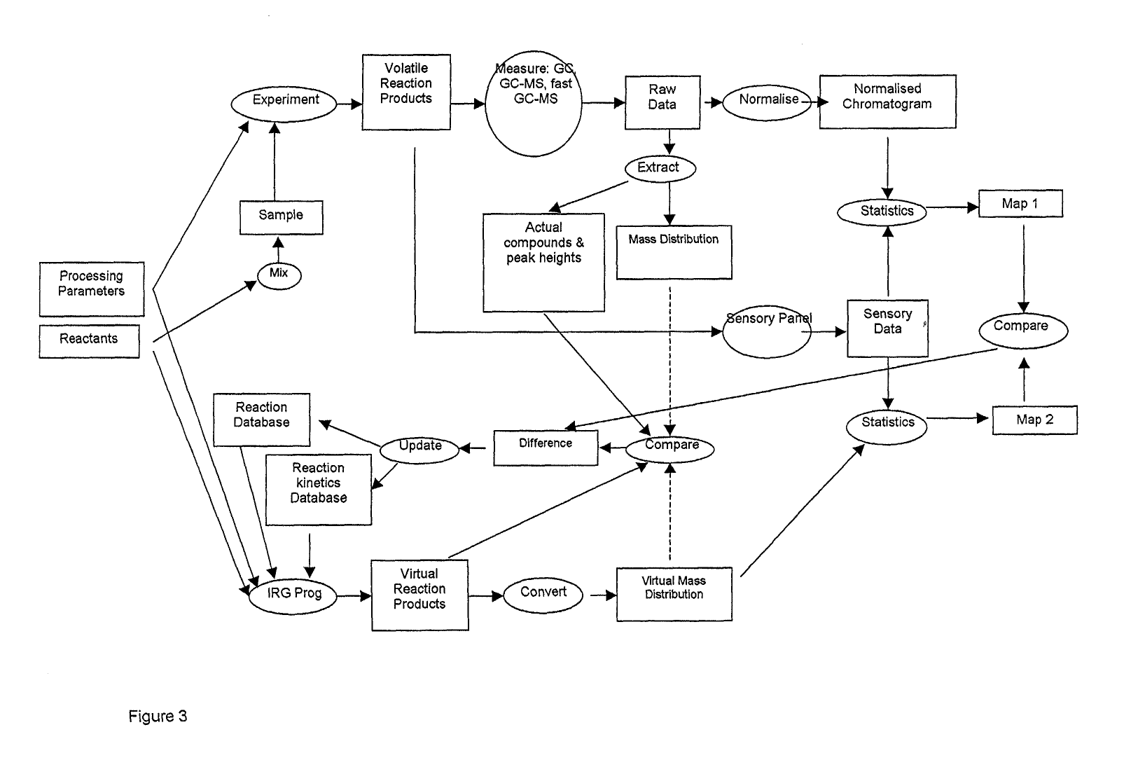

In FIG. 3, an example is given how an assembly of actual and virtual experimentation, and sensory analysis may be used jointly.

### Example 2

This example gives a high level pseudocode for how the IRG may be coded.

Initialise Soup, Reaction Set

Loop

Loop through Reaction Blocks*

Select Random reaction
If (transformation probability > random number)

Select random reactant(s)
If reactant(s) are correct for reaction

Remove bonds
Change atom type & hybridisation
Add bonds
If (mass of product < mass limit) **

Remove reactants from Soup
Add product(s) to Soup

Endif

Endif

Endif

Endloop

Endloop
Italics indicate optional computer instructions:
*if reaction blocks are used
**if a mass limit is used

### Example 3

This example gives the SPL code for the main body of the IRG, similar to Example 2

#============================================================#
uims define expression_generator iterate yes

setvar fh %open($filename3)
setvar fh2 %open($filename5)
%write($fh2 Time $chkprod)

# Call blocks of reactions.
FOR blocks in %range(1 $blocknum 1)

%write($fh “ ”)
%write($fh “Block” $blocks)
%write($fh “ ”)
%write($fh2 “ ”)
%write($fh2 “Block” $blocks)
%write($fh2 “ ”)
setvar inns %set_unpack($inputset[$blocks])
FOR those in $inns

setvar soupmix[$blocks] $soupmix[$blocks] $soupmix[$those]

ENDFOR

# iterate on soupmix[$blocks]

FOR backups in %range(1 10 1)

FOR u in %range(1 10 1)

setvar v 0
FOR t in %range(1 %math($icycles / 100) 1)

setvar randomnu %math($lastprob[$blocks]* %rand( ))
setvar reactionnumber“”

FOR roulette in %range($totalnum[$blocks] 1 −1)

IF %LTEQ($randomnu $cumulist[$blocks][$roulette])

setvar reactionnumber $roulette

ENDIF

ENDFOR
setvar runreaction %arg($reactionnumber $totallist[$blocks])
setvar reacttype %substr($runreaction 1 2)
IF %streql(R1 $reacttype)

# Call unimolecular reaction with random reactants

FOR alpha in %range(1 4 1)

setvar soupsize %count($soupmix[$blocks])
setvar j %math(%int(%math(%math($soupsize − 0.0002) * %rand( ))) +

1.0001)

setvar soupmol %arg($j $soupmix[$blocks])

IF %gt(%strlen($soupmol) 0)

setvar scommand %cat(‘%’ $runreaction‘(‘“ $soupmol ”’)’)

setvar mproduct %eval($scommand)

IF %gt(%strlen($mproduct) 1)

setvar soupmix[$blocks] %item_remove($j $soupmix[$blocks])

setvar mproduct %remwater(“$mproduct”)

setvar soupmix[$blocks] $soupmix[$blocks] $mproduct

%uppaths($soupmol $runreaction “$mproduct”)
%uptable($soupmol $runreaction “$mproduct”)
%upretable($runreaction)
setvar v %math($v + 1)

ELSE
ENDIF

ENDIF

ENDFOR
ELSE

# Call bimolecular reaction with random selections of two reactants

IF %streql(R2 $reacttype)

FOR alpha in %range(1 4 1)

setvar soupsize %count($soupmix[$blocks])
setvar n %math(%int(%math(%math($soupsize − 0.0002) * %rand( ))) +

1.0001)

setvar first %arg($n $soupmix[$blocks])
setvar j %math(%int(%math(%math($soupsize − 0.0002) * %rand( ))) +

1.0001)

IF %eq($j $n)
ELSE

setvar second %arg($j $soupmix[$blocks])
IF %gt(%trlen($first) 0)

IF %gt(%strlen($second) 0)

setvar soupmols %cat($first . $second)
setvar scommand %cat(‘%’ $runreaction‘(‘“ $soupmols ”’)’)
setvar mproduct %eval($scommand)
IF %gt(%strlen($mproduct) 1)

IF %gt($n $j)

setvar soupmix[$blocks] %item_remove($n

$soupmix[$blocks])

setvar soupmix[$blocks] %item_remove($j

$soupmix[$blocks])

ELSE

setvar soupmix[$blocks] %item_remove($j

$soupmix[$blocks])

setvar soupmix[$blocks] %item_remove($n

$soupmix[$blocks])

ENDIF
setvar mproduct %remwater(“$mproduct”)
setvar soupmix[$blocks] $soupmix[$blocks] $mproduct
%uppaths($first $runreaction “$mproduct” )
%uptable($first $runreaction “$mproduct” )
%uppaths($second $runreaction “$mproduct” )
%uptable($second $runreaction “$mproduct” )
%upretable($runreaction)
setvar v %math($v + 1)

ELSE
ENDIF

ENDIF

ENDIF

ENDIF

ENDFOR

ENDIF

ENDIF

ENDFOR
setvar chksum “”

# check for the presence of compounds in current soupmix.

IF %streql(yes $pcheck)

FOR x in %range(1 %count($soupmix[$blocks]))

setvar dummy %smiles_to_mol(m1 %arg($x $soupmix[$blocks]))
FOR y in %range(1 %count($chkprod))

IF %sln_search2d(m1 %arg($y $chkprod) mutual norm 1)

IF $chksum[$y]

setvar chksum[$y] %math(1 + $chksum[$y])

ELSE

setvar chksum[$y] 1

ENDIF

ENDIF

ENDFOR

ENDFOR

ENDIF
%write($fh2 %arg(4 %time( )) $chksum)
%write($fh %arg(4 %time( )) $v)

ENDFOR

# Make a temporary save of the soupmix and paths

echo “Saving backup file ...”
%tmp_file_save(%math($backups * 10) $blocks $backupname)
echo “Backup file saved.”

ENDFOR

IF %streql(yes $timevms)

# Write multiple virtual mass spec graph data to file
# Uses the current block of the soupmix not rather than the whole.

setvar size 1
setvar mass “”
setvar w %printf(“%02d” $blocks)
setvar fh3 %open(%cat($vmsname $w.txt))
FOR j in %range(%count($soupmix[$blocks]) 1−1)

setvar dummy %smiles_to_mol(m1 %arg($j $soupmix[$blocks]))
setvar mass[$j] %int(%molmass(m1))

ENDFOR
setvar mass %sortn($mass)
setvar n 1
FOR k in %range(%math(%count($mass) − 1)1 −1)

IF %eq(%arg($k $mass) %arg(%math($k + 1) $mass))

setvar n %math($n + 1)
setvar $mass %item_remove(%math($k + 1)
$mass)

ELSE

%write($fh3 %arg(%math($k + 1) $mass)
%math($n * $size))
setvar n 1

ENDIF

ENDFOR
%write($fh3 %arg(1 $mass) %math($n * $size))
%close($fh3)

ENDIF

ENDFOR
%close($fh2)
%close($fh)
Example 4
Basic rules for writing each reaction in SMILES notation and
three examples of reactions typical for Maillard, as found in
literature and how they are coded into SMILES strings and
reactions for the IRG.
Basic rules for SMILES:
# Instructions for adding to data base:
# Is this an UNARY or a BINARY reaction type?
# UNARY
# R1_1_1_sugar
# Pattern for matching against, atoms start counting at 0 from the left
# Binary reactions have two patterns, atom numbers continue from the
first pattern
# onto the second
# C(═O)C(O)C(O)
# The numbers of atoms which have restrictions to the atoms joined
to them
# −1 terminates the list
# 0 3 4 5 −1
# These are the restrictions as atom type letter and hybridisation number
# H3 H3 H3C3 H3
# Other restriction state if at least one Hydrogen must be present
# N N Y N
# Catstring is for adding water if required, the number assigned to it
# follows on from the last atom of the pattern
# Both unary and binary reactions use this. If not used then NA replaces it.
# NA
# bonds to be removed as the numbers of the atoms which are on each end
# 2
# 2 3
# 4 5
# bonds to be added as the numbers of the atoms on each end with
bondtypes
# 1
# 2 3 2
# Note: The numbering in each of the 2D representations is the same
as that used
# for the atoms on converting into SMILES notation.
# Example 4a: R2_3_15_pyrroline+TZ,1/32

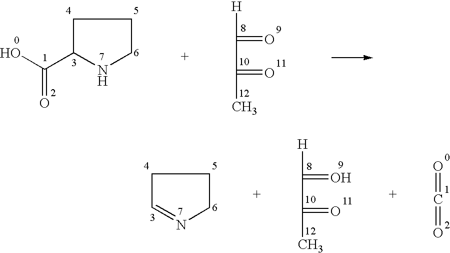

# reaction in SMILES code:

BINARY

R2_{—}3_{—}15_{—}1_pyrroline

OC(═O)C1CCCN1

C(═O)C(═O)C

0 3 4 5 6 7 8 12−1

H3 H3 H3 H3 H3 H3 H3 H3

N N N N N N N N

NA

4

0 1 13 37 89

3

0 1 2

3 7 2

8 9 1

# Added 27.4.99 (SR)

# J. E. Hodge, F. D. Mills and B. E. Fisher, Cereal Sci. Today 17, 34-40 (1972)

# Checked 10.5.99 (FH)

### # Example 4

### R2_{—}10_{—}1b_rS+AAMeCHOpyrrol

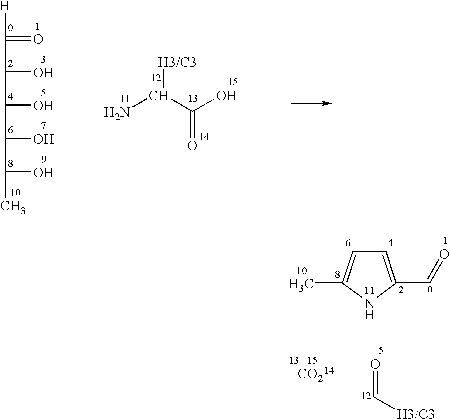

BINARY

R2_{—}10_{—}1 brS+AAMeCHOpyrrol

C(═O)C(O)C(O)C(O)C(O)C

NCC(═O)O

0 3 5 7 9 10 11 12 15-1

H3 H3 H3 H3 H3 H3 H3 H3C3 H3

N N N N N N N Y N

NA

9

23 24 45 67 68 89 11 12 12 13 13 15

2 4 2

2 11 1

6 8 2

8 11 1

12 5 2

13 15 2

# water molecules not explicitly drawn

# Added 20.9.99 (SR). Comparable to R2_{—}10_{—}1b_asugarAA but on rhamnose.

# R. Tressl, E. Kersten, C. Nittka and D. Rewicki. Maillard Reactions

# in Food and Health, Proceedings of 5th Int. Symp. on Maillard Reactions

# 26 Aug.-1 Sept. 1993. (RSC Special publication 151, 1994, p.51)

### # Example 4

### R2_{—}8_{—}14b_{—}2thiopent3on

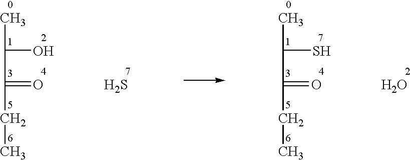

BINARY

R2_{—}8_{—}14b_{—}2thiopent3on

CC(O)C(═O)CC

0 1 2 5 6 7 -1

H3 H3 H3 H3 H3 H3

N N N N N N

NA

1

1 2

1

1 7 1

# Added 17.8.99 (FH)

# changed to OH/SH-substitution J.Agric.Food Chem.1999,47,1626. -25.8.99 (FH)

### Example 5

Example of blocks of reactions as may be used in the reaction database, according to the order in which reactions occur in the Maillard process, but the same reaction may occur in more than one block (FIG. 4). Other arrangements are possible.

### Example 6

Experimental validation with virtual mass distribution (VMD) was obtained by comparison of an actual mass distribution (MMD) with a virtual mass distribution. The conditions for the simulations were: 100 molecules glucose, 100 molecules threonine, 6000 iterations, pH=7, Temperature=120° Celsius. The conditions for the real experiment are: equimolar mixture of glucose and threonine, in a buffered solution pH=7, processed during 1 hour at 120° Celsius.

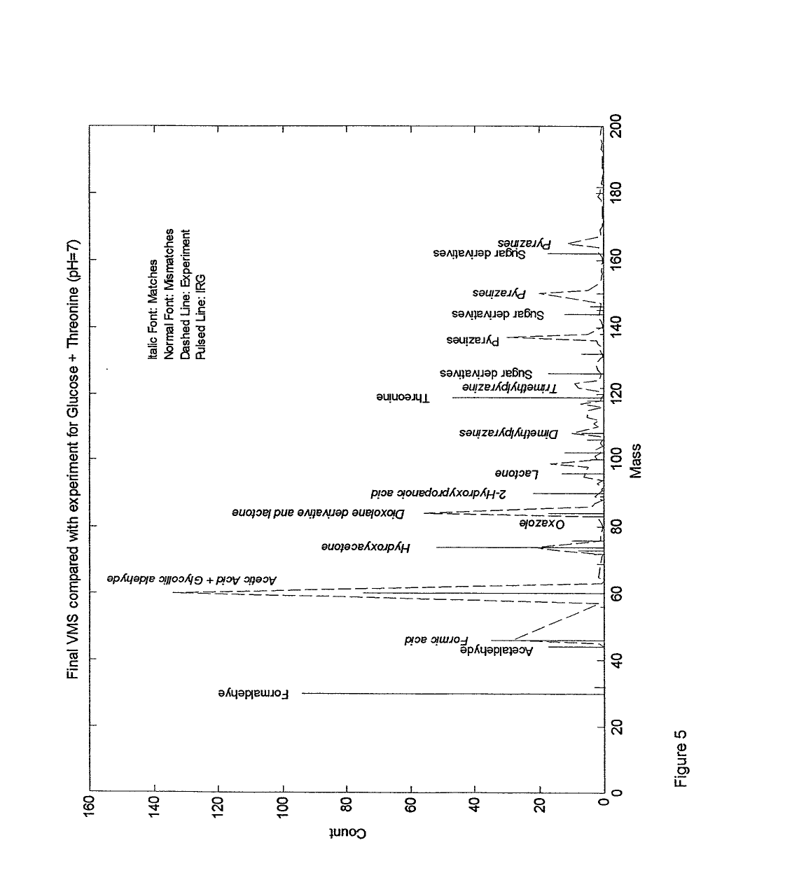

In FIG. 5, the MMD, the VMD, and the matches have been printed in different fonts. Clearly, the formation of formic acid, acetic acid, glycolic aldehyde, hydroxyacetone, lactones, oxazoles, and some pyrazines can bve seen. There are also a number of mismatches: a number of start components and intermediates, such as threonine, formaldehyde, acetaldehyde, and various sugar derivatives are present in the IRG ‘soup’ but not in the experimental results. The IRG has also failed to match some the substituted pyrazines as well as some of the smaller peaks.

1. Method for simulating a chemical process, which process may comprise multiple branches of reaction pathways and/or feed back/forward loops and/or parallel reaction branches by an iterative procedure of applying:
a ‘Reaction Set’ describing transformations that may take place in the chemical process that is to be simulated,and probabilities of said transformations
a ‘Soup’ of molecules representing the state of the system.

2. Method according to claim 1, wherein during the iterative procedure part or all of the reaction products are added back to the Soup.

3. Method according to claim 1, wherein the Soup at the start of the reaction is equal to the starting mixture of molecules.

4. Method according to claim 1, wherein the ‘Reaction Set’ comprises:
a reaction database, comprising various transformations that may take place in the chemical process to be simulated,
a reaction kinetic database, comprising relative probabilities for the transformations in the reaction database.

5. Method according to claim 1, wherein iterative procedure is a computer-readable format encoded by:
Initialise Soup and Reaction Set (containing reaction database and reaction
kinetic database) and optionally Filter
Loop
Loop through reaction blocks
Select Random reaction
If (transformation probability > random number)
Select random reactant(s)
If reactant(s) are correct for reaction
Remove bonds
Change atom type & hybridisation
Add bonds
If (reaction product equals Filter)
Remove reactants from Soup
Add product(s) to Soup
Endif
Endif
Endif
Endloop
Endloop
or any functional equivalent thereof, wherein the Italics indicate optional computer instructions.

6. Method according to claim 1, wherein wherein the iterative procedure is coded as a computer programme directly loadable in the internal memory of a computer.

7. Process according to claim 1, wherein an actual mass distribution is obtained by performing part or all of the reactions that are simulated, wherein the actual mass distribution is compared with the Soup, and wherein the difference of the actual mass distribution and the Soup is used to update the Reaction Set.

8. Process according to claim 7, wherein the actual mass distribution is obtainable by conventional chemical analysis of the reaction products or the volatile fraction thereof.

9. Process according to claim 8, wherein the conventional chemical analysis involves Gas Chromatography and/or Mass Spectroscopy techniques.

10. Process according to claim 9, wherein the chemical analysis is combined by computerised processing of the analytical data.

11. Process according to claim 7, wherein the reactions performed to obtain the actual mass distribution data are carried out in a robotised way.

12. A computer program product directly loadable into the internal memory of a digital computer, comprising software code portions for the simulation of complex chemical reaction pathways by iteratively applying a set of operations to:
a Soup of molecules representing the current state of the system,
a ‘Reaction Set’ describing transformations that may take place in the chemical process that is to be simulated,and probabilities of said transformations to yield molecules.

13. A computer programme product directly loadable into the internal memory of a digital computer, comprising software code portions coding for:
Initialise Soup and Reaction Set (containing reaction database and reaction kinetic database)
Loop
Loop through reaction blocks
Select Random reaction
If (transformation probability > random number)
Select random reactant(s)
If reactant(s) are correct for reaction
Remove bonds
Change atom type & hybridisation
Add bonds
If (reaction product equals Filter)
Remove reactants from Soup
Add product(s) to Soup
Endif
Endif
Endif
Endloop
Endloop
or any functional equivalent thereof, wherein the Italics indicate optional computer instructions.

14. Computerized system comprising means for entering mass distribution data, process variables to be set at the start of a chain of reactions, reactants, and a computer programme for predicting process variables and/or reactants to obtain new desired mass distribution data using an iterative procedure, based upon already entered mass distribution data, process variables, and reactants and means for providing output.

15. Process according to claim 1, wherein the simulation is obtainable by iteratively applying a set of operations or computer intructions using a computer programme to:
A ‘Soup’ of molecules representing the current state of the system
A ‘Reaction Set’ describing transformations and probabilities that may take place in the chemical process to be simulated, to produce molecules, for simulating complex chemical reactions when such product is run on a computer, and wherein the iteration is effected by a computer programme directly loadable in the internal memory of a computer, and wherein the computer programme contains two main elements:
computer instructions for running the reactions using the Reaction Set,
computer instructions for the iterative procedure of running the reactions, selecting molecules, and producing output.

16. Process according to claim 15, wherein during the iterative procedure the newly formed compounds are added back to the Soup, and form (part of) the virtual mass distribution.

17. Process according to claim 15 or 16, wherein the Soup at the start of the reaction is equal to the starting mixture of molecules.

18. Computerized system comprising means for entering fingerprint data or reactants and process variables to be set at the start of a chain of reactions, and a computer programme for predicting process variables to obtain new desired fingerprint data using an iterative procedure, based upon already entered fingerprint data and process variables, and means for providing output.
